(19) United States
(12) Patent Application Publication
(10) Pub. No.: US 2004/0000313 A1
(43) Pub. Date: Jan. 1, 2004

(54) Spunbonded/meltblown/spunbonded laminate face mask

(75) Inventors: Melissa Robyn Gaynor, Roswell, GA (US); Jeffrey Lawrence McManus, Canton, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/184,589

(22) Filed: Jun. 28, 2002

(51) Int. Cl. A62B 18/02; A62B 23/02

(52) U.S. Cl. 128/205.27; 128/205.29

(57) ABSTRACT

The present invention provides filtration materials and face masks that include a spunbonded/meltblown/spunbonded (SMS) laminate.

### FIELD OF THE INVENTION

The present invention relates to face masks and gas permeable filter fabrics.

### BACKGROUND OF THE INVENTION

As is generally known, face masks have been designed to greatly reduce, if not prevent, the transmission of liquids and/or airborne contaminates through the face mask to the wearer of the face mask. In surgical procedure environments, such liquid sources include a patient's perspiration, patient liquids, such as blood, and life support liquids such as plasma and saline. Examples of airborne contaminates include, but are not limited to, biological contaminates, such as bacteria, viruses and fungal spores. Such contaminates may also include particulate material such as, but not limited to, lint, mineral fines, dust, skin squames and respiratory droplets. A measure of a fabrics ability to prevent the passage of such airborne materials is sometimes expressed in terms of “filtration efficiency”.

Many face masks were originally made of cofton or linen. Face masks fashioned from these materials, however, permitted transmission or “strike-through” of various liquids encountered in surgical procedures. In these instances, a path was established for transmission of biological contaminates, either present in the liquid or subsequently contacting the liquid, through the face mask. Additionally, in many instances face masks fashioned from cotton or linen provide insufficient barrier protection from the transmission there through of airborne contaminates. Furthermore, these articles were costly, and of course laundering and sterilization procedures were required before reuse.

Disposable face masks have largely replaced linen face masks. Advances in disposable face masks include the formation of such articles from totally liquid repellent fabrics and/or apertured films which prevent liquid strike-through. In this way, biological contaminants carried by liquids are prevented from passing through such fabrics. However, in some instances, face masks formed from apertured films, while being liquid and airborne contaminate impervious, are, or can become over a period of time, uncomfortable to wear. Furthermore, such face masks are relatively more costly than face masks containing only nonwoven webs.

In some instances, face masks fashioned from liquid repellent fabrics, such as fabrics formed from nonwoven polymers, sufficiently repel liquids and are more breathable and thus more comfortable to the wearer than nonporous materials. However, these improvements in comfort and breathability provided by such nonwoven fabrics have generally occurred at the expense of barrier properties or filtration efficiency.

One type of nonwoven fabric, a spunbonded/meltblown/spunbonded (SMS) laminate, has been widely used in surgical garments, such as gowns and drapes, due to its excellent barrier properties and relatively low cost. To date, SMS laminates have not been used in commercially available face masks due to their previous inability to provide acceptable levels of filtration while maintaining a desirable level of breathability and comfort to the wearer. Consequently, the search for face mask materials, which will provide liquid strike-through protection, microbial penetration resistance, breathability, and comfort at a relatively low cost, continues. Therefore, there exists a need in the art for filtration fabrics, face masks and methods for making the same, which provide improvements in any of the following properties: liquid strike-through protection, breathability, and comfort, as well as, improved filtration efficiency.

### SUMMARY OF THE INVENTION

The present invention is provides a face mask that includes a spunbonded/meltblown/spunbonded (SMS) laminate wherein the SMS comprises an electret material that is thermally point bonded. The SMS laminate may include a ferroelectric material. The SMS laminate may also include a ferroelectric material selected from the group consisting of perovskites, barium titanate, barium strontium titanate, lead titanate and mixtures thereof. Each of the spunbonded layers and the meltblown layer of the SMS laminate may include a ferroelectric material.

In one desirable embodiment the SMS laminate includes a ferroelectric material and a telomer. In a more desirable embodiment the SMS laminate includes barium titanate and a polyolefin-anhydride telomer. Desirably, at least one of the layers of the SMS laminate includes from about 0.01 to about 50 percent by weight of the ferroelectric material and from 0.01 to about 25 percent by weight telomere based on the weight of the layer.

Desirably, at least one of the layers of the SMS laminate includes from about 0.5 to about 5 percent by weight of the ferroelectric material and from 1 to about 5 percent by weight telomer based on the weight of the layer. Desirably, the SMS laminate has a basis weight of about 0.8 to about 2 ounces per square yard.

The present invention also provides a face mask that includes a mouth and nose covering portion wherein the nose and mouth covering portion is a single layer of a thermally point bonded, gas pervious SMS laminate that is electret treated. The SMS laminate may include a ferroelectric material and/or a ferroelectric material selected from the group consisting of perovskites, barium titanate, barium strontium, titanate, lead titanate and mixtures thereof. Each of the layers may include a ferroelectric material. The SMS laminate may include both a ferroelectric material and a telomere, particularly barium titanate and a polyolefin-anhydride telomer. Desirably, at least one of the layers of the gas pervious SMS laminate includes from about 0.01 to about 50 percent by weight of a ferroelectric material and from 0.01 to about 25 percent by weight telomer based on the weight of the layer. More desirably, at least one of the layers of the gas pervious SMS laminate includes from about 0.5 to about 5 percent by weight of a ferroelectric material and from 1 to about 5 percent by weight telomer based on the weight of the layer. Suggested SMS laminates have a basis weight of about 0.8 to about 2 ounces per square yard.

In another embodiment, the present invention also a face mask that includes a mouth and nose covering portion that consists essentially of a thermally point-bonded spunbonded/meltblown/spunbonded laminate having a basis weight of from about 0.8 ounces per square yard to about 2 ounces per square yard; having a bond area in the range of from about 10 percent to about 20 percent; wherein each layer of the SMS laminate includes: from about 0.5 to about 5 percent by weight of a ferroelectric material based on the weight of the layer; and from 1 to about 5 percent by weight of a telomer based on the weight of the layer. Suggested ferroelectric materials are selected from the group consisting of perovskites, barium titanate, barium strontium, titanate, lead titanate and mixtures thereof and the telomer is selected from the group consisting of polyolefin-anhydride telomers and mixtures thereof.

### BRIEF DESCRIPTION OF THE DRAWINGS

For a more complete understanding of the present invention and for the further advantages thereof, reference is now made to the following description taken in conjunction with the accompanying drawings, in which:

FIG. 1 is an illustration of a first exemplary face mask.

FIG. 2 is an illustration of second exemplary face mask.

FIG. 3 is an illustration of a spunbonded/meltblown/spunbonded (SMS) fabric laminate.

FIG. 3 is an perspective view of a third exemplary face mask.

FIG. 4 is a view of the third exemplary face mask.

### DEFINITIONS

As used herein, the term “composite” refers to a material which may be a multicomponent material or a multilayer material. These materials may include, for example, blends or one or more polymers, a polymer composition that includes an additive or a filler or other particulates, laminates, or any combination thereof.

As used herein, the term “elastic” refers to any material, including a film, fiber, nonwoven web, or combination thereof, which upon application of a biasing force, is stretchable to a stretched, biased length which is at least about 150 percent, or one and a half times, its relaxed, unstretched length, and which will recover at least 15 percent of its elongation upon release of the stretching, biasing force.

As used herein, the terms “electret” or “electreting” means a treatment that imparts charges to a dielectric material, for example an olefin polymer. The charge includes layers of positive or negative charges trapped at or near the surface of the polymer, or charge clouds stored in the bulk of the polymer. The charge also includes polarization charges which are frozen in alignment of the dipoles of the molecules. Methods of subjecting a material to electreting are known by those skilled in the art. These methods include, for example, thermal, liquid-contact, electron beam and corona discharge methods. One particular technique of subjecting a material to electrostatic electreting is the technique disclosed in U.S. Pat. No. 5,401,466, the entire contents of which is hereby incorporated herein by reference. This technique involves subjecting a material to a pair of electrical fields wherein the electrical fields have opposite polarities. A process of forming an electret nonwoven web using a DC corona discharge is disclosed in U.S. Pat. No. 6,365,088, the entire contents of which is also hereby incorporated herein by reference.

The term “ferroelectric material” is used herein to mean a crystalline material which possesses a spontaneous polarization which may be reoriented by the application of an external electric field. The term includes any phase or combination of phases exhibiting a spontaneous polarization, the magnitude and orientation of which can be altered as a function of temperature and externally applied electric fields. The term also is meant to include a single ferroelectric material and mixtures of two or more ferroelectric materials of the same class or of different classes. The term further includes a “doped” ferroelectric material, i.e., a ferroelectric material which contains minor amounts of elemental substituents, as well as solid solutions of such substituents in the host ferroelectric material. Ferroelectric materials exhibit a “Curie point” or “Curie temperature” which refers to a critical temperature above which the spontaneous polarization vanishes. The Curie temperature often is indicated herein as “T_{c}”.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers are microfibers which may be continuous or discontinuous, are generally smaller than 10 microns in average diameter (using a sample size of at least 10), and are generally tacky when deposited onto a collecting surface.

As used herein the terms “nonwoven fabric” and nonwoven web” mean a web having a structure of individual fibers or threads which are interlaid, but not in an identifiable manner as in a knitted fabric. Nonwoven fabrics or webs have been formed from many processes such as, for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein the terms “spunbonded fibers” and “spunbond fibers” refer to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No.3,502,763 to Hartman, and U.S. Pat. No. 3,542,615 to Dobo et al. Spunbond fibers are generally not tacky when they are deposited onto a collecting surface. Spunbond fibers are generally continuous and have average diameters (using a sample size of at least 10) larger than 7 microns, more particularly, between about 10 and 25 microns.

As used herein, the term “stitchbonded” refers to a process in which materials (fibers, webs, films, etc.) are joined by stitches sewn or knitted through the materials. Examples of such processes are illustrated in U.S. Pat. No. 4,891,957 to Strack et al. and U.S. Pat. No. 4,631,933 to Carey, Jr.

As used herein, the term “thermal point bonding” involves passing materials (fibers, webs, films, etc.) to be bonded, for example, between a heated pattern roll and an anvil roll, a pattern roll and a flat anvil roll or two patterned rolls. The pattern roll is usually patterned in some way so that the entire fabric is not bonded across its entire surface. As a result, various patterns for calender rolls have been developed for functional as well as aesthetic reasons. Typically, the percent bonding area varies from around 10 percent to around 30 percent of the area of the fabric laminate. As is well known in the art, thermal point bonding holds the laminate layers together and imparts integrity to each individual layer by bonding filaments and/or fibers within each layer.

As used herein, “ultrasonic bonding” means a process performed, for example, by passing the web between a sonic horn and anvil roll as illustrated in U.S. Pat. No. 4,374,888 to Bornslaeger.

As used herein, any given range is intended to include any and all lesser included ranges. For example, a range of from 25-75 would also include 30-75; 45-60 27-39 so forth.

Test Methods

NaCl Filtration Efficiency:

The NaCl Filtration Efficiency is a measure of the ability of a fabric or web to stop the passage of small particles through it. A higher efficiency is generally more desirable and indicates a greater ability to remove particles. NaCl efficiency is measured in percent according to the TSI Inc., Model 8130 Automated Filter Tester Operation Manual of February 1993, P/N 1980053, revision D, at a flow rate of 85 liters per minute using 0.2 micron sized NaCl particles and is reported as an average of 3 sample readings. The test result is reported as penetration and must be subtracted from 100 percent to obtain efficiency. This method can also yield the pressure drop (resistance) of a sample using 0.2 micron particles. The manual is available from TSI Inc. at PO Box 64394, 500 Cardigan Rd, St. Paul, Minn. 55164.

Bacterial Filtration Efficiency with Chance in Pressure (BFE w/ΔP):

The measure of the ability for a nonwoven web to resist bacteria penetration was measured according to ASTM Standard F2101-01, the entire contents of which is hereby incorporated herein by reference. This test procedure was performed to determine the bacterial filtration efficiency (BFE) of filtration materials. ASTM F2101-01 test procedure provides a greater challenge to filtration materials than may be expected during normal use. The ASTM F2101-01 test procedure was used with little or no modification to provide a standard procedure for comparing filtration exemplary materials. The differential pressure (ΔP) test measures the air exchange differential of filtration materials.

Particle Filtration Test (PFE):

The Particle Filtration Test uses small latex spheres to simulate environmental particles and is used to evaluate filter efficiency. This test was performed in accordance with ASTM Test Method F1215-89 with the following variation: the charge of the spheres was not neutralized. The latex spheres were 0.1±0.003 microns in diameter. The spheres were propelled toward an approximately 91.5 square centimeter circular piece of the test fabric. Results were reported as percent filtration efficiency for removal of particles within the specified range and a higher number indicates relatively greater filtration efficiency.

### DETAILED DESCRIPTION OF THE INVENTION

Reference will now be made in detail to embodiments and examples of the invention. Each example is provided by way of explanation of the invention, and not as a limitation of the invention. For example, features illustrated or described as part of one embodiment can be used with another embodiment to yield still further embodiments. It is intended that the present invention include modifications and variations to the embodiments described herein that come with the scope of the claims and equivalents thereto.

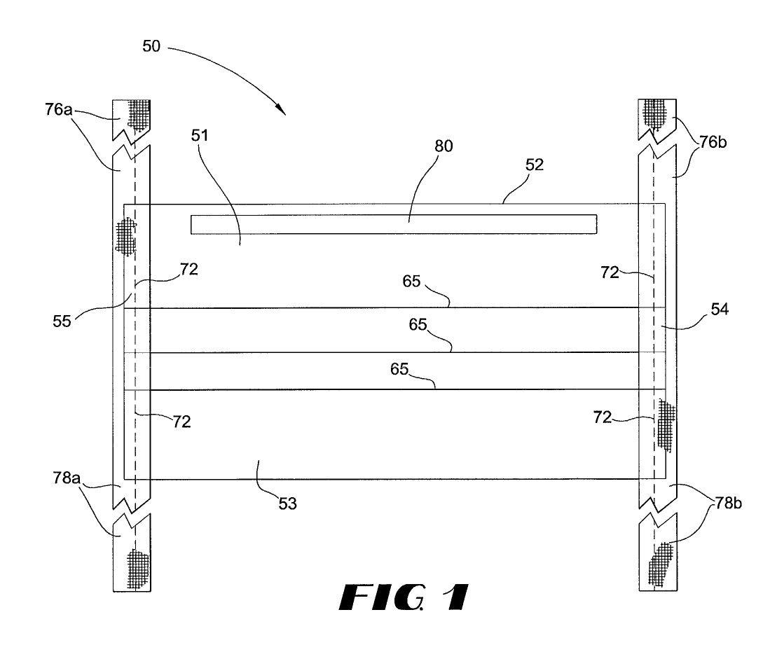

The present invention relates to any style or configuration of face mask that includes as a filtration material a spunbonded/meltblown/spunbonded (SMS) fabric laminate that is electret treated. Examples of face masks are provided in FIGS. 1, 2 and 4 and include, but are not limited to, other face masks used and/or designed for surgical, clean room and industrial uses and include known surgical style masks, procedure style masks, dust masks and clean room masks and any other types of face masks and face mask designs that can be adapted to use the filtration fabric of the present invention. Exemplary face masks are illustrated and described in U.S. Pat. No. 4,941,470 and U.S. Pat. No. 5,467,765, the entire contents of which are hereby incorporated herein by reference. At least one layer of the face masks of the present invention includes a SMS laminate. More desirably the nose and mouth covering portion of the face masks of the present invention are made from an electret treated SMS laminate that is air permeable. And, in one particularly desirable embodiment, the present invention provides a face mask in which the nose and mouth covering, i.e. the filtering portion of the mask, consists of a single layer of SMS laminate that is electret treated and includes a ferroelectric material and, more desirably, also includes a telomer. In this particular embodiment, the SMS laminate provides the filtration functionality of a mask in a single, distinct layer.

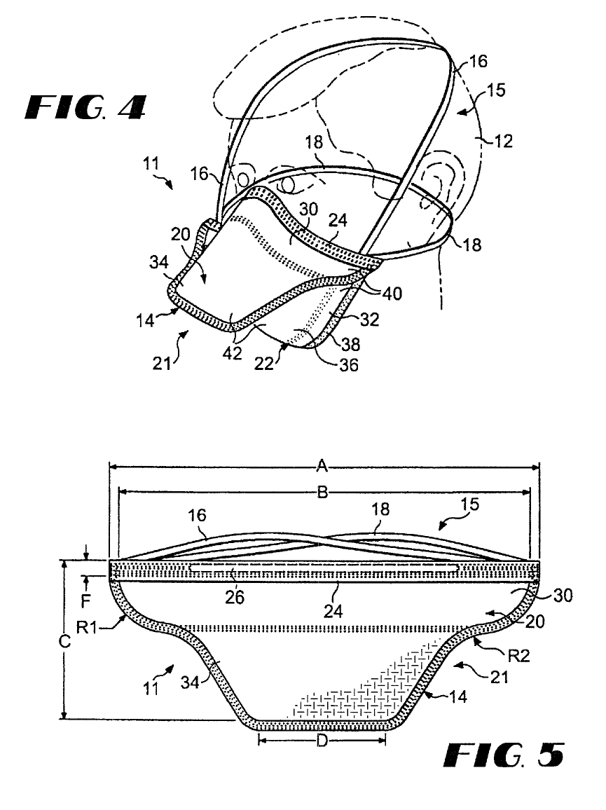

Traditional face masks, particularly face masks used by health care professionals, incorporate multiple layers of material in order to provide the barrier properties desired to protect the wearer from airborne pathogens. Surgical and examination face masks can also protect patients from infection, i.e. microflora traveling from the wearer to the patient. The present invention provides an electret treated SMS laminate that provides barrier protection while providing comfort to the wearer. A schematic illustration of an exemplary SMS laminate 10 is provided in FIG. 3. The illustrated exemplary SMS laminate 10 includes a first spunbonded layer 2, a meltblown layer 4 and a second spunbonded layer 6 that are bonded to form a single integral laminate by bonded regions 8. Using a single SMS laminate to form the body portion of a face mask also provides cost advantages, replacing multiple more costly layers of material and reducing the cost of converting the layers into a face mask.

An illustration of an exemplary face mask is provided in FIG. 1. Generally, the face mask 50 includes a body portion 51 that is typically rectangular shaped and covers the nose and mouth of a wearer of the mask. The face mask also includes a pair of ties 54 and 55 or other means for securing the mask to the wearers face. The body portion of the face mask that covers the nose and mouth of a wearer acts as a filter removing airborne contaminates and is desirably air permeable. Conventional surgical masks and other face masks include separate layers to filter out airborne contaminates. The separate layers must be placed one over another and attached to each other at their periphery and to the ties or other means for securing during conversion of the layers into a face mask. The present invention provides a face mask that includes a bonded three layer SMS laminate in which the layers of the laminate do not require attachment to each other at their periphery during conversion of the laminate into a face mask.

SMS laminates are known and are described in greater detail in and U.S. Pat. No. 4,041,203 to Brock et al., U.S. Pat. No. 5,169,706 to Collier and in U.S. Pat. No. 5,188,885 to Timmons et al., the entire contents of which are hereby incorporated herein by reference. Generally, an SMS laminate 10 is a laminate formed from one or more fibrous materials and include a spunbonded layer 2, a meltblown layer 4 and a spunbonded layer 6. SMS laminates are typically formed from a composition that includes one or more thermoplastic polymers. The main polymeric component of a layer of the SMS is referred to as the host polymer. SMS laminates may include other fibrous materials including natural fibers. The choice of fibers and thermoplastic polymer(s) depends upon, for example, fiber cost and the desired properties, e.g., liquid resistance, vapor permeability or liquid wicking, of the finished drape. For example, suitable thermoplastic resins may include, but are not limited to, synthetic resins such as those derived from polyolefins, polyesters, polyamides, polyacrylics, etc., alone or in combination with one another. Monocomponent and multicomponent, or conjugate, synthetic fibers may be used alone or in combination with other fibers. Other suitable fibers include natural fibers such as cotton, linen, jute, hemp, cotton, wool, wood pulp, etc. Similarly, regenerated cellulosic fibers such as viscose rayon and cuprammonium rayon, or modified cellulosic fibers, such as cellulose acetate, may likewise be used. Blends of one or more of the above fibers may also be used if so desired.

Monocomponent and conjugate synthetic fibers suitable for the present invention can be produced from a wide variety of thermoplastic polymers that are known to form fibers. Suitable polymers for forming the SMS laminates include, but are not limited to, polyolefins, e.g., polyethylene, polypropylene, polybutylene, and so forth; polyamides, e.g., nylon 6, nylon 6/6, nylon 10, nylon 12 and so forth; polyesters, e.g., polyethylene terephthalate, polybutylene terephthalate and so forth; polycarbonates; polystyrenes; thermoplastic elastomers, e.g., ethylenepropylene rubbers, styrenic block copolymers, copolyesterelastomers and polyamide elastomers and so forth; fluoropolymers, e.g., polytetrafluoroethylene and polytrifluorochloroethylene; vinyl polymers, e.g., polyvinyl chloride, polyurethanes; and blends and copolymers thereof. Particularly suitable polymers for forming the drapes of the present invention are polyolefins, including polyethylene; polypropylene; polybutylene; and copolymers as well as blends thereof. Of the suitable polymers for forming conjugate fibers, particularly suitable polymers for the high melting component of the conjugate fibers include polypropylene, copolymers of polypropylene and ethylene and blends thereof, more particularly polypropylene, and particularly suitable polymers for the low melting component include polyethylenes, more particularly linear low density polyethylene, high density polyethylene and blends thereof; and most particularly suitable component polymers for conjugate fibers are polyethylene and polypropylene.

Suitable fiber forming polymers may additionally have thermoplastic elastomers blended therein. In addition, the polymer components may contain additives for enhancing the crimpability and/or lowering the bonding temperature of the fibers, and enhancing the abrasion resistance, strength and softness of the resulting webs. For example, the low melting polymer component may contain about 5 percent by weight to about 20 percent by weight of a thermoplastic elastomer such as an ABA block copolymer of styrene, ethylenebutylene and styrene. Such copolymers are commercially available and some of which are identified in U.S. Pat. No. 4,663,220 to Wisneski et al. An example of highly suitable elastomeric block copolymers is KRATON G-2740. Another group of suitable additive polymers is ethylene alkyl acrylate copolymers, such as ethylene butyl acetate, ethylene methyl acrylate and ethylene ethyl acrylate, and the suitable amount to produce the desired properties is from about 2 weight percent to about 50 weight percent, based on the total weight of the low melting polymer component. Yet other suitable additive polymers include polybutylene copolymers and ethylene-propylene copolymers. In particular, SMS laminates that are formed from one or more polyolefin resins are especially suitable for the face masks. Desirably, the polyolefin resins are polypropylene or polyethylene resins. Most desirably, the polyolefin resins are polypropylene resins.

The face masks of the present invention can be made from a variety of substrates in addition to the SMS laminate, including, but not limited to, woven fabrics, nonwoven fabrics, scrims, knit fabrics, and combination thereof. Desirably, the face masks of the present invention are formed from only one layer of bonded SMS nonwoven fabric. However, in the case of multiple layers, the SMS layer provides the filtration functionality. When multiple discrete layers are combined form a mask, the layers are generally positioned in a juxtaposed or surface-to-surface relationship and all or a portion of the layers may be bound to adjacent layers.

The face masks of the present invention comprise at least one SMS laminate that is electret treated. Desirably, the face masks of the present invention comprise a SMS laminate that includes in at least one layer a ferroelectric material and, more desirably, at least one layer that includes a ferroelectric material and further includes a telomer. More desirably, the face masks comprise a SMS laminate that includes a ferroelectric material and a telomer in each layer. Specifically, in one desirable embodiment, the two spunbonded layers and the interior meltblown layer each include a ferroelectric material and a telomer. Desirably, the meltblown layer in the SMS laminate of the present invention is an electret meltblown layer. Typically, the meltblown layer has a basis weight of less than about 1.5 osy so that overall breathability of the face mask is maintained at an acceptable level (According to military standards, a pressure drop of less than 5 mm H₂O per cm² constitutes an acceptable level of breathability). Desirably, the meltblown layer has a basis weight of less than about 1.0 osy. More desirably, the electret layer has a basis weight of about 0.2 osy to about 0.8 osy.

The spunbonded layers 2 and 6 and meltblown layer 4 of the SMS laminate 10 are desirably bonded, more desirably point bonded at thermally point bonded regions 8 as depicted in FIG. 3. Desirably, the layers are bonded after the layers are formed and before the laminate is further processed. Thermal point bonding involves passing a fabric or web of fibers to be bonded, for example the SMS laminate, between, for example a heated pattern roll and an anvil roll. The pattern roll is usually, though not always, patterned in some way so that the entire fabric is not bonded across its entire surface.

These bonding rolls can include a pattern roll and anvil roll in combination or two pattern rolls. As a result, various patterns for rolls have been developed for functional as well as aesthetic reasons. One example of a pattern known as a “wire weave” pattern is illustrated in FIG. 3 of U.S. Pat. No. 5,964,742 to McCormack et al. The wire weave pattern looks like a window screen and has about an 18 percent bond area. Other common patterns include a diamond pattern with repeating and slightly offset diamonds with about a 16% bond area. Typically, the percent bonding area varies from around 10% to around 30% of the area of the fabric laminate web. As is well known in the art, the spot bonding holds the laminate layers together as well as imparts integrity to each individual layer by bonding filaments and/or fibers within each layer.

Electret treatment of the SMS laminate further increases filtration efficiency by drawing particles to be filtered toward the fibers of the filter by virtue of their electrical charge. Electret treatment can be carried out by a number of different techniques. An exemplary technique of electret treatment is described in U.S. Pat. No. 5,401,446 to Tsai et al. assigned to the University of Tennessee Research Corporation, the entire contents of which are hereby incorporated herein by reference. Tsai describes a process whereby a web or film is sequentially subjected to a series of electric fields such that adjacent electric fields have substantially opposite polarities with respect to each other. Thus, one side of the web or film is initially subjected to a positive charge while the other side of the web or film is initially subjected to a negative charge. Then, the first side of the web or film is subjected to a negative charge and the other side of the web or film is subjected to a positive charge. Such webs are produced with a relatively high charge density. The process maybe carried out by passing the web through a plurality of dispersed non-arcing electric fields like, for example, between a charging wire or bar and a charged roller at a certain gap, where the field and gap may be varied over a range depending on the charge desired in the web. The web may be charged at a range of about −30 kVDC/cm to 30 kVDC/cm or more particularly −10 kVDC/cm to 25 kVDC/cm and still more particularly −5 kVDC/cm to about 25 kVDC/cm. The gap may be about 0.25 inch (6.5 mm) to about 2 inches (51 mm) or more particularly about 0.5 to 1.5 inches (13 to 38 mm) or still more particularly about an inch (25.4 mm). Other methods of electret treatment are known in the art such as that described in U.S. Pat. Nos. 4,215,682 to Kubik et al, 4,375,718 to Wadsworth, 4,592,815 to Nakao and 4,874,659 to Ando. A method of inline electret treating a nonwoven web is described in U.S. Pat. No. 6,365,088 to Knight et al., the entire contents of which are hereby incorporated herein by reference.

One or more of the layers of the SMS laminate includes a ferroelectric material that possesses polarization which may be reoriented by the application of an external electric field. Examples of ferroelectric materials include, without limitation, perovskites, tungsten bronzes, bismuth oxide layered materials, pyrochlores, alums, Rochelle salts, dihydrogen phosphates, dihydrogen arsenates, guanidine aluminum sulfate hexahydrate, triglycine sulfate, colemanite, and thiourea. Ferroelectric materials may be inorganic or organic in nature. Inorganic ferroelectric materials are desired because of their generally superior thermal stability. Examples of various exemplary ferroelectric materials are discussed below. Perovskites are a particularly desirable ferroelectric material due to their ability to form a wide variety of solid solutions from simple binary and ternary solutions to very complex multicomponent solutions. Some examples include, but are not limited to, BaSrTiO₃, BaTiO₃, Pb(Co_{0.25}Mn_{0.5}W_{0.5})O₃ and numerous forms of barium titanate and lead titanate doped with niobium oxide, antimony oxide, and lanthanum oxide, to name a few by way of illustration only. The ability to form extensive solid solutions of perovskite-type compounds allows one skilled in the art to systematically alter the electrical properties of the material by formation of a solid solution or addition of a dopant phase. In addition, perovskite-related octahedral structures have a structure similar to that of perovskites, and are likewise exemplary ferroelectric materials, examples include, but are not limited to, lithium niobate (LiNbO₃) and lithium tantalate (LiTaO₃). These materials are intended to be included in the term “perovskites.” Additionally, further examples of ferroelectric materials include bismuth oxide layered materials which comprise complex layered structures of perovskite layers interleaved with bismuth oxide layers. An exemplary bismuth oxide layered compound is lead bismuth niobate (PbBiNb₂O₉). A more detailed description of suitable ferroelectric materials is provided in U.S. Pat. No. 6,162,535 to Turkevich et al., the entire contents of which are hereby incorporated herein by reference.

The amount of ferroelectric material contained in at least one of the layers of the SMS laminate desirably ranges from about 0.01 to about 50 percent by weight of the layer. The ferroelectric material may be included in one, two or all three of the layers of the SMS laminate. Desirably, the amount of ferroelectric material within a layer is between about 0.05 to about 30 percent by weight and more desirably be in a range of from about 0.1 to about 20 percent by weight of the layer and, still more desirably, be in a range of from about 0.5 to about 5 percent by weight of the layer. On a percent by volume basis, the amount of ferroelectric material present in a layer generally will be in a range of from about 0.001 to about 13 percent by volume and desirably from about 0.01 to about 8 percent by volume and more desirably from about 0.1 to about 5 percent by volume and still more desirably from about 0.1 to about 2 percent by volume of the layer. Desirably, the ferroelectric material is dispersed within the composite or matrix of the layer or layers of the SMS laminate as described herein below.

One or more layers of the SMS laminate comprise a polymeric matrix with the ferroelectric material dispersed therein. The ferroelectric material can be located randomly throughout the polymeric matrix and, desirably, is substantially uniformly distributed throughout the polymeric matrix of the particular layer. In this regard, the composite desirably comprises a zero/three composite. As used herein a “zero/three” composite refers to the dimensional connectivity of the ferroelectric material and the polymer comprising the composite. Connectivity is a macroscopic measure of the composite structure which considers the individual structures (i.e. the ferroelectric material and the polymer) continuity in the x, y, and z dimensions. The first number refers to continuity of the ferroelectric material within the composite and a zero rating indicates that the ferroelectric particles form discrete phases which are discontinuous in the x, y and z dimensions. The second number refers to the continuity of the polymeric portion of the composite and a three rating indicates that the polymeric portion of the composite is continuous in each of the x, y and z dimensions.

In addition, the desired particle size of the ferroelectric material will vary with respect to the particular manufacturing process (e.g. meltblown or spunbond) as well as the desired physical attributes of the face mask made there from. For example, with respect to melt extruded fibers or filaments, the longest dimension of the particles typically should be no greater than about 50 percent of the diameter of the orifice through which the composite is extruded. Desirably, the ferroelectric material has a longest dimension in a range of from about 10 nanometers to about 10 micrometers. It has been found that many nonwoven fiber forming processes inherently orient the ferroelectric particle such that the longest dimension of the particle is oriented substantially parallel with the machine direction of the fabric (i.e. the direction in which the fabric is produced) and thus a wide range of particle sizes are suitable for use in such materials. The longest dimension of the average ferroelectric particle is desirably less than about 2 micrometers and/or desirably less than about 50 percent of the fiber thickness. In addition, the ferroelectric material can comprise nanosize particles. Suitable ferroelectric materials can be synthesized to form particles of the desired size and/or can be destructured to form particles of the desired size. As used herein, the term “destructured” and variations thereof means a reduction in size of the ferroelectric particles.

The composite of the layer containing the ferroelectric material can be formed and processed by various methods. As an example, the composite may be formed by the following process: (i) destructuring the ferroelectric material in the presence of a liquid and a surfactant to give destructured particles, wherein the liquid is a solvent for the surfactant and the surfactant is chosen to stabilize the destructured particles against agglomeration; (ii) forming a composite of the stabilized, destructured ferroelectric material particles and the polymeric component(s) of the layer; and (iii) extruding the composite material to form the layer as desired. A mixture of the stabilized, destructured ferroelectric material particles and a thermoplastic polymer may be prepared by a variety of methods. As specific examples, methods of making such materials are described in U.S. Pat. No. 5,800,866 to Myers et al., the entire contents of which are hereby incorporated herein by reference.

In addition to the ferroelectric material included in the one or more layers of the SMS laminate, it is desirable that the layer(s) that includes a ferroelectric material also includes a telomer. As used herein, “telomer” includes a polymer having one or more functional groups located at the chain ends of the polymer. Telomers are also referred to as telechelic polymers and are known in the art. Various telomers and methods of making the same are described in Encyclopedia of Polymer Science and Engineering, vol. 16, pg. 494-554 (1989). As particular examples, polyolefin-anhydride telomers (a polyolefin polymer having one or more anhydride end groups) suitable for use with the present invention are commercially available from Exxon Chemical Company of Houston, Tex. under the tradename EXXELOR and from Uniroyal Chemical Company under the tradename POLYBOND. The telomer can be a homopolymer, copolymer, terpolymer or other composition. However, with copolymers or other polymers with a plurality of repeat units, the terminal or end functional groups of telomers do not have the same chemical functionality as the repeat units. Telomers can have either one or a plurality of functional end groups and the average number of functional end groups for a given telomer will vary with the method of formation, degree of chain branching and other factors known to those skilled in the art.

The telomer and/or other polymers used in combination with the host polymer(s) that forms the layer(s) is desirably compatible or substantially compatible with the host polymer. As used herein “substantially compatible” means mixtures or blends of polymers wherein the composition produces a single DSC melting curve (determined by evaluating a composition by differential scanning calorimetry (DSC)) which is indicative of sufficient compatibility or miscibility to avoid formation of substantially discrete domains within the continuous phase of the host polymer. Desirably, the telomer has a chain or backbone which is substantially similar to that of the host polymer and even more desirably identical to that of the host polymers. For example, it the host polymer that is used to form the layer is a polypropylene resin, it is suggested that the telomer has a backbone that includes propylene units such a maleic anhydride grafted polypropylene. A suggested commercially available example of a maleic anhydride grafted polypropylene telomer is POLYBOND 3200 which can be obtained from the Crompton Corporation. The functional end groups of the telomer are desirably end groups capable of hydrogen bonding or undergoing a reaction, such as a condensation reaction, to form a covalent bond. Generally, polar functional groups are desirable such as, for example, an aldehyde, acid halide, acid anhydrides, carboxylic acids, amines, amine salts, amides, sulfonic acid amides, sulfonic acid and salts thereof, thiols, epoxides, alcohols, acyl halides, and derivatives thereof. Suggested polar functional end groups include acid anhydride, carboxylic acid, amides, amines, and derivatives thereof.

The telomer is desirably present in an amount of from about 0.1 percent to about 25 percent of the total weight of the composite and even more desirably comprises from about 0.5 percent to about 15 percent of the composite and still more desirably comprises from about 1 percent to about 10 percent of the composite. It is suggested that the functional end groups desirably comprise a weight percent of between about 0.0004 percent and about 0.2 percent and even more desirably between 0.002 percent and 0.1 percent by weight of the total polymeric portion of the composite.

The desired polymer composition and rheology of the layer(s) will be selected in accord with the particular manufacturing process of the polymeric material. It is desirable that the telomer has a melt-flow rate (MFR) and/or melt-index (MI) which is compatible with the selected formation process. By utilizing a telomer with similar rheological properties, such as MI or MFR, it is believed a more homogeneous blend can be produced and processing will generally be improved. However, the criticality in matching melt-flow rates or using telomers with specific properties will vary with the particular process employed. As an example, with respect to spunbond fiber formation, desirably the telomer has an MI at least equal to that of the host thermoplastic polymer and even more desirably has an MI greater than that of the host thermoplastic polymer in order to improve spinning and fiber formation. However, with meltblown fiber formation the telomer can have an MFR below that of the host polymer.

The telomer is desirably blended with the host thermoplastic polymer component of the layer in a manner designed to achieve a substantially homogeneous mixture or blend. As one example, the polymers can be blended using a master batch or dry blend technique. In this regard, the respective polymers are initially blended to form a master batch, typically in the form of pellets, prills or powder, having a higher weight percent of the telomer than ultimately desired in the polymeric matrix. The master batch is then mixed with pellets comprising the host thermoplastic polymer component and processed through, for example, an extruder. The ratio of the master batch and host thermoplastic polymer component is selected, based upon the weight percent of telomer in the master batch, to achieve the desired ratio in the final composition. Other blending techniques are also believed suitable for use with the present invention.

The SMS laminates of the present invention may be treated with various chemicals in order to impart desirable characteristics. For example, the SMS laminate may be treated with chemicals in order to enhance the liquid repellency of the SMS laminate. Chemicals for enhancing liquid repellency of nonwoven fabrics are known in the art, and any such chemical is suitable for the present invention. Particularly useful chemicals include, but are not limited to, fluorochemicals, such as Zonyl FTS manufactured by E. I. DuPont de Nemours & Company, of Wilmington, Del. The SMS laminate may also be treated with an antistatic agent.

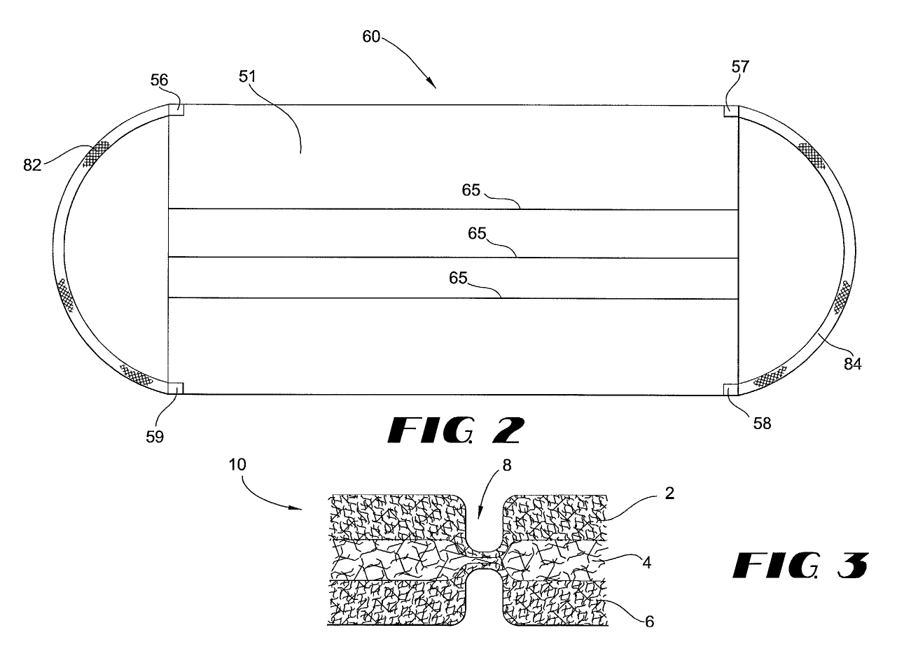

The face masks of the present invention may be manufactured by various methods of making face masks known to those of ordinary skill in the art. Referring to FIGS. 1 and 2, for example, a single layer of electret-treated SMS laminate of the present invention may be cut to a desired shape and dimensions, for example, a 4-inch by 6-inch rectangular, nose and mouth covering portion 51 which may also be referred to the body portion of a face mask 50. Face mask 50 illustrated in FIG. 1 and face mask 60 illustrated in FIG. 2 are just two examples of the many face mask constructions that may include an SMS laminate of the present invention.

An optional nose piece 80 may be positioned and adhered proximate to and substantially parallel to a long edge 52 or 53 of the rectangular nose and mouth covering portion 51. Ties or other means for securing the face mask to a wearer may be attached to the SMS laminate by attachment means such as sewing, adhesives, stitch bonding, ultrasonic bonding, and so forth. Specifically, a pair of tie strings 82 and 84 may be attached to each of the upper corners 56 and 57 and the lower corners 58 and 59 of the rectangular portion 51 as illustrated in FIG. 2. The tie strings may be stitch bonded 72 as illustrated in FIG. 1 or adhesively bonded to the SMS laminate or to a strip provided at the edge of the SMS laminate. Examples of stitch bonding processes are illustrated in U.S. Pat. No. 4,891,957 to Strack et al. and U.S. Pat. No. 4,631,933 to Carey, Jr., the contents of which are incorporated herein by reference in their entirety.

In contrast to the prior art, various layers do not need to be aligned and joined together to form a body portion and binder strips are not needed to cover and bind the edges of the layers of the body portion. However, strips may be provided at the edges to provide additional structural integrity, to provide attachment of tie strings, and/or a nose piece or for aesthetic or other purposes. If strips are not provided to cover the nose strip and the points of attachment of tie strings, it is suggested the face mask may then be worn by a person with the nose strip and points of facing outward.

Looking still to FIGS. 1 and 2, the body portion 51 of the face masks 50 and 60 are formed from a filtration material that has an upper edge or edge portion 52, a lower edge or edge portion 53, and two opposed sides or side edge portions 54 and 55, respectively. The body portion 51 of the masks 50 and 60 may also be provided with several folds or pleats 65, desirably from 1 to 5 pleats, arranged substantially parallel to the upper edge 52 of the generally rectangular body portion 51. Additionally, the masks 50 and 60 may be folded to form horizontal pleats, which unfold when slipped over the face of the wearer to provide sufficient room and adapt to the facial features of the wearer. Alternatively, the mask may contain vertical pleats (not shown) that are arranged substantially parallel to the two opposed edges 54 and 55 of the generally rectangular body portion.

In conventional multilayer face masks, the multiple layers of the body portion will be joined to one another such that there will be little tendency to separate or tear, particularly at the edges of the body portion. With such multilayer face masks, it is necessary to employ at least one binding strip along the bottom and side edge portions or along all of the edge portions of the mask to reduce any tendency which may exist for the layers to separate or the body portion to tear. Face masks of the present invention do not require a binding strip along the top, bottom and side edge potions. However, one or more binding strips may be provided along the either the top, bottom or side edge portion(s). The binding strip may be formed from a strip or strips of material, desirably nonwoven material, folded along their longitudinal axes. The edge portions of the mask may then be placed within the fold and the binding strip either sewn or adhesively secured to the edge portions.

The upper or top edge portion of the body portion of filtration material generally includes a binding strip of the type described immediately above. That is, the binding strip is formed from a strip of nonwoven material which is folded on its longitudinal axis such that the fold receives the porow pad and is suitably secured therein, either with adhesive means or by stitching through both outer surfaces of the binding strip and the intermediate filtration material. As an alternative to placing the body portion within the fold formed in a binding strip, the latter may be secured on one surface of the body portion by use of adhesive means or sewing the strip to the body portion.

Means for fixing the mask to or retaining the mask on the head of a wearer may be provided at the upper edge and lower edge portions of the mask. This may take the form of separate tie strips secured to the upper edge and lower edge of the mask at the sides of the mask. The tie strips may be secured directly to the body portion or to binding strip affixed on or partly enclosing the upper edge portion and the lower edge portion. Alternatively, the affixing means may take the form of an oversized length of binding strip of the same material and width as the binding strip described above, which may be used such that the strip, when symmetrically placed, has a length extending laterally well beyond the side edges of the body portion, providing thereby ends of the binding strip equivalent to tie strips, which may be tied behind the head of the wearer. Generally, a length of binding strip on the order of about 25 to 33 inches in length, is suitable on a mask which has dimensions of approximately 6 inches on a side. Like the binding strip, this last described embodiment, employing extended ends which serve as tie strips, may be arranged such that the filtration material is secured within the fold of the binding strip or the binding strip may be secured to the top edge and lower edge portions of the body portion by stitching the binding strip to the body in contact with either surface of the body portion.

Another embodiment includes securing separate tie strips at or adjacent the upper edge and lower edge portions to a binding formed by using either an outer layer or an inner layer having dimensions larger than the other layers of the substantially rectangular pad of filtering material. The oversized layer may be folded back upon itself to receive the remaining layers within the fold formed in the oversized layer. All layers may then be secured at their edge portions, either with suitable adhesive means placed between the overlapping folded edge portion and the surface which it adheringly contacts or by stitching through the edge portions of the layers and the folded overlapping portion. Whether the tie strips used as means for affixing the mask to the head of a wearer are formed from an oversized strip of binding material or attached separately, when formed from folded material, the fold in the tie strip is, preferably, sewn or adhesively closed.

A nose piece 80 may also be provided at the upper edge portion of the body portion of the face mask with a thin strip of bendable or deformable material such as, for instance, aluminum or thin gauge steel as illustrated in FIGS. 1 and 5. A nose piece can be enclosed within the fold of a binding strip and maintained in position between the fold and stitching formed through the binding strip or those portions of the body portion serving as the binding strip and the upper edge portions of the body portion. Alternatively, a nose piece may be secured adhesively, such as between the binding strip and the outer surface of one of the layers of the body portion. An example of how this may be accomplished is to attach the nose with an adhesive or a piece to the adhesive side of an oversized piece of pressure sensitive tape which is adhesively fixed to an outer surface of the body portion or an inner surface of a binding strip such that the metal strip is enclosed between the tape and either the body portion or binding strip. Alternatively, a double-faced pressure sensitive adhesive may be used to locate the nose piece in the positions described above. A strip of cover material or spunbonded material may then be placed over the free adhesive surface of the double-faced tape. Another alternate embodiment employs the metallic nose piece strip with a self-adhering back provided by a suitable adhesive applied to a surface thereof.

Although the face masks described above have a substantially square or rectangular body portion and are attached to a wearer by as many as four tie strips, other face mask designs are within the scope of the present invention. Another exemplary suitable face mask design is illustrated and described in U.S. Pat. No. 4,662,005, assigned to Kimberly-Clark Corporation, wherein the face mask has a cup or pouch-like configuration, which engages with a wearer's chin and also has two tie strings on opposite sides of an upper edge for tying around a wearer's head. Other designs are also within the scope of the present invention. Alternate face masks designs that can be used for the present invention, include, but are not limited to, the designs illustrated in U.S. Design Pat. Nos. 347,090 and 347,713 and/or described in U.S. Pat. Nos. 5,322,061 and 6,173,712, which are issued to Brunson et al. and are hereby incorporated herein by reference in their entireties.

The exemplary face mask illustrated in FIGS. 4 and 5 is one of the face masks developed by Brunson et al. FIGS. 4 and 5 illustrate a mask 11 disposed on the head of a wearer 12 (shown in ghost lines) and constructed in accordance with one embodiment of the present invention. A general description of such a disposable mask follows. As shown in FIGS. 4 and 5, mask 11 has the general shape of a cup or cone defining an opening 66 that is generally against the wearer's face when worn, and a sealed end, generally 21. The filter portion of the mask is generally disposed in the area of sealed end 21 and held off the wearer's face 12. Such an “off-the-face” style mask provide a breathing chamber to permit cooler wear and easier breathing. The volume of air contained within body 14 should be optimized to prevent retention of excessive amounts of exhaled air within body 14 at normal breathing rates. By properly selecting the size of body 14, excessive heating of the air within body 14 is reduced and dizziness from prolonged periods of breathing exhaled air is minimized.

In the embodiment illustrated in FIGS. 4 and 5, body 14 may comprise an upper panel 20 and a lower panel 22 of a generally trapezoidal configuration. The upper panel 20 and the lower panel 22 may have an identical configuration and may be bonded together along three sides. In one embodiment, the sides may be bonded by heat and/or ultrasonic sealing. Bonding in this manner adds important structural integrity to mask 11. The fourth, unbonded side of the upper panel 20 is open and includes a top edge 24. The top edge 24 is arranged to receive an elongated malleable member 26 as shown in FIG. 5. Malleable member 26 is provided so that top edge 24 of mask 11 can be configured to closely fit the contours of the nose and cheeks of wearer 12.

In order to reduce “blow-by” associated with normal breathing of wearer 12, malleable strip 26 is preferably positioned in the center of top edge 24 and has a length in the range of 50 percent to 70 percent of the total length (A) of top edge 24, as shown in FIG. 5. Malleable member 26 is desirably constructed from an aluminum strip, more desirably quarter-tempered aluminum, with a rectangular cross-section, but may also be a moldable or malleable steel or plastic member. The fourth, unbonded side of the lower panel 22 may include a bottom edge 38. Top edge 24 of the upper panel 20 and bottom edge 38 of lower panel 22 cooperate with each other to define the periphery or opening 66 of body 14 which contacts the face of wearer 12, helping to optimize the barrier formed between the periphery of body 14 and the face of wearer.

Suggested relative dimensions for mask 11 are illustrated in FIG. 5. The precise dimensions may be modified to accommodate wearers having particularly small or large facial features. The ratio between the width (C) and the minor length (D) of the trapezoid portion of mask 11 is suggested to be approximately 1 to 1 and a suggested ratio between the major length of body 14 (A) and the minor length (D) is approximately 3 to 1. The mask 11 illustrated in FIGS. 4 and 5 includes a body 14 that is secured to wearer 12 by means of fastening system 15. The fastening system 15 may comprise resilient and elastic straps or securing members 16 and 18. The mask 11 may be positioned over the nose and under the chin of the wearer 12. Straps 16 and 18 may be formed from a resilient polyurethane. The straps 16 and 18 may also be constructed from elastic rubber or a covered stretch yarn and the like. The covered stretch yarn may consist of an elastomeric material wrapped with nylon or a polyester.

Face masks of the present invention may further include other components including but not limited to a plastic eye shield that can be provided with a face mask to provide optional eye protection. Plastic shields that can be attached to a surgical or other face mask to provide additional protection are known and are illustrated and described in U.S. Pat. Nos. 5,383,450 to Hubbard et al. and 6,213,125 to Reese et al., the entire contents of which is hereby incorporated herein by reference. In addition the SMS laminate and the face mask may further include various chemical additives to or topical chemical treatments in or on one or more layers, including, but not limited to, surfactants, colorants, antistatic chemicals, antifogging chemicals, fluorochemical blood or alcohol repellents, lubricants, or antimicrobial treatments.

Although only a few exemplary embodiments of this invention have been described in detail above and the focus has been directed to surgical face masks, there are many other applications for the face masks of the present invention. Other applications include, but are not limited to, laboratory applications, clean room applications, such as semiconductor manufacture, agriculture applications, mining applications, and environmental applications. Moreover, those skilled in the art will readily appreciate that many modifications are possible to the exemplary embodiments without materially departing from the novel teachings and advantages of this invention. All such modifications are intended to be included within the scope of this invention as defined in the following claims. In addition, the present invention is described above and below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

Several examples of SMS fabrics of varying basis weights were produced from a melt blended mixture of a polypropylene resin, about 5 weight percent of a ferroelectric material, specifically barium titanate, about 5 weight percent of a telomer, POLYBOND 3200 maleic anhydride grafted polypropylene telomer obtained from the Crompton Corporation and about 1 weight percent of colorant with remainder being polypropylene resin. The polypropylene resin used in the spunbonded layers was PF 304 polypropylene resin obtained from Basell and polypropylene resin used in the meltblown layer was 3746G polypropylene resin also obtained from Exxon Mobil. The additives were incorporated in all the spunbond and meltblown banks by adding them to the blending system prior to extrusion of the polymers and additives and, thus, each layer of the SMS laminate contained the stated amounts of additives, the ferroelectric material and the telomer. The basis weights were adjusted by varying the line speed of the SMS line. The basis weights of the SMS laminate and the meltblown layer of each of the examples are provided in Table 1 below. The spunbonded layers were symmetric and can be calculated by subtracting the basis weight of the meltblown layer from the basis weight of the SMS laminate. The spunbonded layers and meltblown layer of the SMS were bonded using a wire weave pattern having about 18 percent bond area to form a single, integral SMS laminate.

The SMS fabrics of Examples 1, 2, 3 and 4 were electret treated offline with a portable electret treater. And, the SMS fabrics of Example 5, 6, 7 and 8 were electret treated inline with an electret treater on the SMS machine. The SMS laminate was passed through 2 electric fields, each with a total potential of 15 kV at 3.0 milliamps (mA).

Each field was of opposite polarity so as to charge both sides of the fabric. Each field was generated by a positively charged bar and a negatively charged roll.

Samples of the SMS materials were evaluated for Bacterial Filtration Efficiency (BFE), Particle Filtration Efficiency (PFE), Differential Pressure Drop (ΔP), and Resistance according to the Test Methods described above to evaluate and mimic the use of a single layer of the SMS materials of the examples as a single layer face mask. The test results are provided in Table 1 below.

Examples 9, 10 and 11 did not include a ferroelectric material or a telomer additive. Examples 9 and 10 were not electret treated and Example 11 was electret treated offline.

TABLE 1

| | | | Forming | | | | | |
|---|---|---|---|---|---|---|---|---|
| | Basis | Meltblown | Heights | | | | Δ P | |
| Example | Weight | Weight | of S, M, S | BFE | PFE | Penetration | mmH₂O | Resistance |
| Number | (osy) | (osy) | layers | (%) | (%) | (%) | per cm² | mmH₂O |
| 1 | 1.5 | 0.45 | 9, 9, 9 | 99.3 | 98.8 | — | 1.7 | 6.5 |
| 2 | 1.25 | 0.375 | 10, 12, 12 | 98.7 | 98.3 | — | 1.1 | 4.5 |
| 3 | 1.0 | 0.30 | 9, 9, 9 | 98.2 | 98.0 | — | 0.86 | 3.8 |
| 4 | 1.0 | 0.22 | 10, 12, 12 | 97.3 | 97.7 | — | 0.61 | 2.73 |
| 5 | 1.0 | 0.30 | 9, 9, 9 | 93.2 | 96.5 | 60 | 1.45 | 4.7 |
| 6 | 1.25 | 0.375 | 9, 9, 9 | 96.2 | 98 | 50 | 2.1 | 6.9 |
| 7 | 1.5 | 0.45 | 9, 9, 9 | 98.3 | 98.5 | 41 | 3.05 | 10.3 |
| 8 | 1.25 | 0.375 | 9, 9, 9 | 96.8 | 98.6 | 50 | 2.2 | 7.0 |
| 9 | 1.0 | 0.30 | — | — | 87.6 | 11.52 | — | 6.6 |
| 10 | 0.85 | 0.255 | — | — | 90.5 | 9.5 | — | 5.47 |
| 11 | 1.0 | 0.30 | — | — | 37.8 | 62.2 | — | 7.09 |

The examples show a wide variety of SMS materials with different basis weights that are capable of meeting and in some cases well exceeding the desired face mask properties described. These examples show that it is possible to make a single layer SMS laminate that has the desired filtration efficiency and breathability for a face mask. When compared to current multiple layer face masks, it is apparent that the SMS laminate, single layer face mask is capable of performing at the same levels and in some cases, exceeding the performance levels of multiple layer face masks.

What is claimed is:

1. A face mask comprising a spunbonded/meltblown/spunbonded laminate wherein the spunbonded/meltblown/spunbonded laminate comprises an electret material that is thermally point bonded.

2. The face mask of claim 1, wherein the spunbonded/meltblown/spunbonded laminate comprises a ferroelectric material.

3. The face mask of claim 1, wherein the spunbonded/meltblown/spunbonded laminate comprises a ferroelectric material selected from the group consisting of perovskites, barium titanate, barium strontium titanate, lead titanate and mixtures thereof.

4. The face mask of claim 1, wherein each of the spunbonded layers and the meltblown layer of the spunbonded/meltblown/spunbonded laminate comprise a ferroelectric material.

5. The face mask of claim 1, wherein the spunbonded/meltblown/spunbonded laminate comprises a ferroelectric material and a telomer.

6. The face mask of claim 1, wherein the spunbonded/meltblown/spunbonded laminate comprises barium titanate and a polyolefin-anhydride telomer.

7. The face mask of claim 1, wherein at least one of the layers of the spunbonded/meltblown/spunbonded laminate comprises
from about 0.01 to about 50 percent by weight of the ferroelectric material and
from 0.01 to about 25 percent by weight telomer based on the weight of the layer.

8. The face mask of claim 1, wherein at least one of the layers of the spunbonded/meltblown/spunbonded laminate comprises
from about 0.5 to about 5 percent by weight of the ferroelectric material and
from 1 to about 5 percent by weight telomer based on the weight of the layer.

9. The face mask of claim 1, wherein the spunbonded/meltblown/spunbonded laminate has a basis weight of about 0.8 to about 2 ounces per square yard.

10. A face mask comprising a mouth and nose covering portion wherein the nose and mouth covering portion is a single layer of a thermally point bonded, gas pervious spunbonded/meltblown/spunbonded laminate that is electret treated.

11. The face mask of claim 10, wherein the gas pervious spunbonded/meltblown/spunbonded laminate comprises a ferroelectric material.

12. The face mask of claim 10, wherein the gas pervious spunbonded/meltblown/spunbonded laminate comprises a ferroelectric material selected from the group consisting of perovskites, barium titanate, barium strontium, titanate, lead titanate and mixtures thereof.

13. The face mask of claim 10, wherein each of the spunbonded layers and the meltblown layer of the spunbonded/meltblown/spunbonded laminate comprise a ferroelectric material.

14. The face mask of claim 10, wherein the gas pervious spunbonded/meltblown/spunbonded laminate comprises a ferroelectric material and a telomer.

15. The face mask of claim 10, wherein the gas pervious spunbonded/meltblown/spunbonded laminate comprises barium titanate and a polyolefin-anhydride telomer.

16. The face mask of claim 10, wherein at least one of the layers of the gas pervious spunbonded/meltblown/spunbonded laminate comprises
from about 0.01 to about 50 percent by weight of a ferroelectric material and
from 0.01 to about 25 percent by weight telomer based on the weight of the layer.

17. The face mask of claim 1, wherein at least one of the layers of the gas pervious spunbonded/meltblown/spunbonded laminate comprises
from about 0.5 to about 5 percent by weight of a ferroelectric material and
from 1 to about 5 percent by weight telomer based on the weight of the layer.

18. The face mask of claim 10, wherein the gas pervious spunbonded/meltblown/spunbonded laminate has a basis weight of about 0.8 to about 2 ounces per square yard.

19. A face mask comprising a mouth and nose covering portion that consists essentially of a thermally point-bonded spunbonded/meltblown/spunbonded laminate:
having a basis weight of from about 0.8 ounces per square yard to about 2 ounces per square yard;
having a bond area in the range of from about 10 percent to about 20 percent;
wherein each layer of the spunbonded/meltblown/spunbonded laminate comprises:
from about 0.5 to about 5 percent by weight of a ferroelectric material based on the weight of the layer; and
from 1 to about 5 percent by weight of a telomer based on the weight of the layer.

20. The face mask of claim 19, wherein the ferroelectric material is selected from the group consisting of perovskites, barium titanate, barium strontium, titanate, lead titanate and mixtures thereof and the telomer is selected from the group consisting of polyolefin-anhydride telomers and mixtures thereof.
